(19) United States
(12) Patent Application Publication
(10) Pub. No.: US 2024/0135457 A1
(43) Pub. Date: Apr. 25, 2024

(54) Method and System for Computing Hidden Investment Cost Disclosable to Purchasers and Sellers of Income-Producing Securities

(71) Applicant: FairShares, Inc., Delray Beach, FL (US)

(72) Inventors: David Boydell, Sonoma, CA (US); Jeremy Roseberry, Delray Beach, FL (US)

(73) Assignee: FairShares, Inc., Delray Beach, FL (US)

(21) Appl. No.: 18/273,368

(22) PCT Filed: Feb. 1, 2022
(86) PCT No.: PCT/US22/14787

§ 371 Date: Jul. 20, 2023

Related U.S. Application Data
(60) Provisional application No. 63/144,450, filed on Feb. 1, 2021.
(60) Provisional application No. 63/214,150, filed on Jun. 23, 2021.

(51) Int. Cl. G06Q 40/06

(52) U.S. Cl. CPC G06Q 40/06

(57) ABSTRACT

A system includes: a server configured to compute the hidden cost that a user assumes when they purchase an income-producing security; a system database operably connected to the server; a securities data source operably connected to the system database, wherein the server is further configured to compute the hidden cost, using the securities data, using an equation:

$$Purchaser ’ s Hidden Cost = S * R * ( Distribution Index ) = S * R * \{ \begin{matrix}D for purchases of a stock ; \\ ( D * \frac{T}{L} ) for a purchase of an investment fund\end{matrix} , \qquad ( 2 )$$

where: S=the number of shares the user wants to purchase, R=the user's tax rate on investment income, D=the total distribution per share, T=the amount of elapsed time since the payment period began, and L=the total amount of time in the payment period; and storage configured to store the computed hidden cost.

### PRIORITY CLAIM

The present application claims the priority benefit of U.S. provisional patent application No. 63/144,450 filed Feb. 1, 2021 and entitled “Method and System for Computing Per-Share Distributable Income of a Security,” and of U.S. provisional patent application No. 63/214,150 filed Jun. 23, 2021 and entitled “Method and System for Computing Investment Risk Associated with Purchasing and Selling Income-Producing Securities,” the disclosures of which are incorporated herein by reference.

### CROSS-REFERENCE TO RELATED APPLICATION

This application contains subject matter that is related to the subject matter of the following applications, which are assigned to the same assignee as this application. The below-listed application is hereby incorporated herein by reference in its entirety:

“METHOD AND SYSTEM FOR COMPUTING CORRECT INCOME OF A SECURITY USING UNDISTRIBUTED INCOME,” by Boydell, et al., co-filed herewith.

### SUMMARY

Embodiments of this invention provide a computer-implemented method and system for computing a hidden cost that is disclosable to a user who does one or more of purchase and sell an income-producing security.

A system for computing a hidden cost that a user assumes when they purchase an income-producing security includes: a server configured to control the system, the server further configured to compute the hidden cost that the user assumes when they purchase the income-producing security; a system database operably connected to the server; a securities data source operably connected to the system database, the securities data source configured to provide to the system database on a regular basis securities data comprising an estimated financial distribution of a security of interest, wherein the system database is configured to receive the securities data, wherein the server is further configured to compute the hidden cost, using the securities data, using an equation:

$$Purchaser ’ s Hidden Cost = S * R * ( Distribution Index ) = S * R * \{ \begin{matrix}D for purchases of a stock ; \\ ( D * \frac{T}{L} ) for a purchase of an investment fund\end{matrix} , \qquad ( 2 )$$

where: S=the number of shares the user wants to purchase, R=the user's tax rate on investment income, D=the total distribution per share, T=the amount of elapsed time since the payment period began, and L=the total amount of time in the payment period; and storage operably connected to the server, the storage configured to store the computed hidden cost.

A system for computing a hidden cost that a user assumes when they sell an income-producing security includes: a server configured to control the system, the server further configured to compute the hidden cost that the user assumes when they sell the income-producing security; a system database operably connected to the server; a securities data source operably connected to the system database, the securities data source configured to provide to the system database on a regular basis securities data comprising an estimated financial distribution of a security of interest, wherein the system database is configured to receive the securities data, wherein the server is further configured to retrieve the securities data from the system database, wherein the server is further configured to compute the hidden cost, using the securities data, using an equation:

$$Seller ’ s Hidden Cost = S * ( C - Q ) * ( Distribution Index ) = S * ( C - Q ) * \{ \begin{matrix}D for sales of a stock ; \\ ( D * \frac{T}{L} ) for a sale of an investment fund\end{matrix} , \qquad ( 6 )$$

where: S=a number of shares the user wishes to sell, C=the tax rate on capital gains, Q=the tax rate on qualified income, D=the total distribution per share, T=the amount of elapsed time since the payment period began, and L=the total amount of time in the payment period; and storage operably connected to the server, the storage configured to store the computed hidden cost.

A method for computing the hidden cost that a user assumes when they purchase an income-producing security includes: using a system comprising a server configured to control the system, the server configured to compute the hidden cost that the user assumes when they purchase an income-producing security, the system further comprising a system database operably connected to the server, the system further comprising a securities data source operably connected to the system database, the securities data source configured to provide to the system database on a regular basis securities data comprising an estimated financial distribution of a security of interest, wherein the system database is configured to receive the securities data, retrieving, by the server, the securities data from the system database; computing the hidden cost, by the server, using the securities data, using an equation:

$$Purchaser ’ s Hidden Cost = S * R * ( Distribution Index ) = S * R * \{ \begin{matrix}D for purchases of a stock ; \\ ( D * \frac{T}{L} ) for a purchase of an investment fund\end{matrix} , \qquad ( 2 )$$

where: S=the number of shares the user wants to purchase, R=the user's tax rate on investment income, D=the total distribution per share, T=the amount of elapsed time since the payment period began, and L=the total amount of time in the payment period; and transmitting, by the server, to the storage, the computed hidden cost, the system further comprising storage operably connected to the server, the storage configured to store the computed hidden cost.

A method for computing the hidden cost that a user assumes when they sell an income-producing security includes: using a system comprising a server configured to control the system, the server configured to compute the hidden cost that the user assumes when they sell an income-producing security, the system further comprising a system database operably connected to the server, the system further comprising a securities data source operably connected to the system database, the securities data source configured to provide to the system database on a regular basis securities data comprising an estimated financial distribution of a security of interest, wherein the system database is configured to receive the securities data, retrieving, by the server, the securities data from the system database; computing the hidden cost, by the server, using the securities data, using an equation:

$$Seller ’ s Hidden Cost = S * ( C - Q ) * ( Distribution Index ) = S ( C - Q ) * \{ \begin{matrix}D for sales of a stock ; \\ ( D * \frac{T}{L} ) for a sale of an investment fund\end{matrix} , \qquad ( 6 )$$

where: S=a number of shares the user wishes to sell, C=the tax rate on capital gains, Q=the tax rate on qualified income, D=the total distribution per share, T=the amount of elapsed time since the payment period began, and L=the total amount of time in the payment period; and transmitting, by the server, to the storage, the computed hidden cost, the system further comprising storage operably connected to the server, the storage configured to store the computed hidden cost.

A system for computing a hidden cost that a user assumes when they purchase an income-producing security includes: a server configured to control the system, the server further configured to compute the hidden cost that the user assumes when they purchase the income-producing security; a user device operated by a user, the user device configured to send to the server a request for the hidden cost of a security of interest, the user device operably connected to the server, wherein the server communicates with the user device via one or more of a network connection, the cloud, and a wired connection, wherein the server comprises a login module suitable for use by the user device to log into the server, wherein the server further comprises a user interface suitable for use by the user device to interface with the server following a successful login to the server; a system database operably connected to the server; a securities data source operably connected to the system database, the securities data source configured to provide to the system database on a daily basis securities data comprising an estimated financial distribution of a security of interest, wherein the system database is configured to receive the securities data, wherein the server is further configured to compute the hidden cost, using the securities data, using an equation:

$$Purchaser ’ s Hidden Cost = S * R * ( Distribution Index ) = S * R * \{ \begin{matrix}D for purchases of a stock ; \\ ( D * \frac{T}{L} ) for a purchase of an investment fund\end{matrix} , \qquad ( 2 )$$

where: S=the number of shares the user wants to purchase, R=the user's tax rate on investment income, D=the total distribution per share, T=the amount of elapsed time since the payment period began, and L=the total amount of time in the payment period; storage operably connected to the server, the storage configured to store the computed hidden cost, wherein the server is further configured to export the computed hidden cost to one or more of the user device and an intermediary authorized by the user, wherein the intermediary comprises one or more of an accountant, a tax advisor, a broker-dealer, a custodian, and a data provider; and a network configured to operably connect two or more of the server, the user device, the system database, the securities data source, the storage, and the intermediary, wherein the security distributes one or more distribution types, wherein the distribution types are selected from a list comprising: income, cash, a short-term capital gain, a long-term capital gain, and a special cash distribution, wherein the server is further configured to compute a hidden cost for each distribution type from the security, wherein the server transmits to the storage the hidden costs computed for each distribution type.

A system for computing a hidden cost that a user assumes when they sell an income-producing security includes: a server configured to control the system, the server further configured to compute the hidden cost that the user assumes when they sell the income-producing security; a user device operated by a user, the user device configured to send to the server a request for the hidden cost of a security of interest, the user device operably connected to the server, wherein the server communicates with the user device via one or more of a network connection, the cloud, and a wired connection, wherein the server comprises a login module suitable for use by the user device to log into the server, wherein the server further comprises a user interface suitable for use by the user device to interface with the server following a successful login to the server; a system database operably connected to the server; a securities data source operably connected to the system database, the securities data source configured to provide to the system database on a daily basis securities data comprising an estimated financial distribution of a security of interest, wherein the system database is configured to receive the securities data, wherein the server is further configured to retrieve the securities data from the system database, wherein the server is further configured to compute the hidden cost, using the securities data, using an equation:

$$Seller ’ s Hidden Cost = S * ( C - Q ) * ( Distribution Index ) = S * ( C - Q ) * \{ \begin{matrix}D for sales of a stock ; \\ ( D * \frac{T}{L} ) for a sale of an investment fund\end{matrix} , \qquad ( 6 )$$

where: S=a number of shares the user wishes to sell, C=the tax rate on capital gains, Q=the tax rate on qualified income, D=the total distribution per share, T=the amount of elapsed time since the payment period began, and L=the total amount of time in the payment period; storage operably connected to the server, the storage configured to store the computed hidden cost, wherein the server is further configured to export the computed hidden cost to one or more of the user device and an intermediary authorized by the user, wherein the intermediary comprises one or more of an accountant, a tax advisor, a broker-dealer, a custodian, and a data provider; and a network configured to operably connect two or more of the server, the user device, the system database, the securities data source, the storage, and the intermediary, wherein the security distributes one or more distribution types, wherein the distribution types are selected from a list comprising: income, cash, a short-term capital gain, a long-term capital gain, and a special cash distribution, wherein the server is further configured to compute a hidden cost for each distribution type from the security, wherein the server transmits to the storage the hidden costs computed for each distribution type.

### BRIEF DESCRIPTION OF THE FIGURES

The figures depict various embodiments for purposes of illustration only. One skilled in the art will readily recognize from the following discussion that alternative embodiments of the structure and methods illustrated herein may be employed without departing from the principles described herein.

FIG. 2 is a flow chart of a method for computing a hidden cost of an income-producing security that a user assumes when they purchase the security.

FIG. 3 is a flow chart of a method for computing a hidden cost of an income-producing security that a user assumes when they sell the security.

### DETAILED DESCRIPTION

While the present invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the following description and in the several figures of the drawings, like reference numerals are used to describe the same, similar or corresponding parts in the several views of the drawings.

The embodiments of the invention allow a investor to compute and understand the hidden costs and risk associated with one or more of purchasing and selling income-producing securities. The embodiments of the invention also provide regulated entities with the data needed to disclose these hidden costs to investors in order to meet their regulatory disclosure requirements. Global stock markets use a last holder of record system to distribute income to shareholders. In the last holder of record system, the last investor to own shares on a last day of the payment period is entitled to the entire financial distribution, regardless of how long those shares are held. For example, if investor one has held shares of an income-producing security for one year and then sells those shares to investor two one day before the end of the payment period, investor one will not receive any of the upcoming distribution and investor two will receive the entire distribution, even though investor two only owned the shares for one day.

The current last holder of record system includes, in a price of a security, the security's undistributed income that is payable by the security to the security's shareholders. Therefore, investors who purchase income-producing securities are purchasing two separate and very different interests in those securities. The majority of the investor's capital is used to purchase the actual security. However, a smaller portion of the investor's capital is used to purchase already earned, yet undistributed income the security will distribute on a future date. The investor's capital that was used to purchase this secondary interest in the security's undistributed income will be returned to the investor as a fully taxable distribution. However, this return of the security's undistributed income should not be taxable income. This constitutes a return of a portion of the investor's initial capital and should therefore be excluded from taxation since no income was earned. This is a problem with the current last holder of record system that costs investors money.

For example, if the investor purchases a security for $100 per share that will pay a $2.00 distribution tomorrow, when the distribution is paid, the security's price will drop from $100 per share to $98.00, and the investor will receive a $2.00 per share distribution. This may appear to be a zero-sum game because the investor has lost $2.00 in the value of their shares and has gained $2.00 in distributions. However, the investor loses under this scenario because the investor will owe tax on the $2.00 distribution that the investor receives. If we assume a 50% tax rate, the investor will owe $1.00 in taxes which leaves the investor with a net investment value of $99.00. This investor lost 1% of his or her capital in less than 24 hours.

The reason this investor experienced a loss is that the investor was taxed on a return of their capital when the distribution they purchased was returned to them. A return of capital should not be taxable. Embodiments of the invention provide a method and system for disclosing these hidden costs to investors prior to the investor making a purchase or sale, so that the investor can attempt to mitigate their losses and make better investing decisions.

Currently, there are no systems and methods available to disclose investment hidden costs to users related to one or more of their purchases of income-producing securities and their sales of income-producing securities so that they can make an informed decision regarding whether the hidden cost is acceptable to the user.

Investment hidden cost related to security purchases pertains to one or more of a tax loss the user may incur due to paying taxes on a return of the user's capital and a reduced purchasing power caused by the security's undistributed income.

Investment hidden cost related to security sales pertains to the potential difference in tax rates between the user being taxed on a security's undistributed income, which is a component of the security's price and thus creates a capital gain versus waiting until the distribution is paid and receiving a potentially lower tax rate on distribution income.

Further, those who manage money on behalf of others have a legal fiduciary duty to do one or more of assess these hidden costs for their client and disclose the hidden costs to their client. For example, money managers have a duty to assess these hidden costs for their client to make sure the hidden costs are suitable for the particular client.

Embodiments of the invention provide a system to disclose to the user these hidden costs. Other embodiments of the invention provide a system that disclose the hidden cost to the user in real time.

The hidden cost the user assumes when they purchase or sell income-producing securities can be variable. That is, the hidden cost can change from day to day. Further, numerous processes and steps are required to properly assess these hidden costs. Users generally lack one or more of the knowledge and the ability to properly assess the hidden costs. Embodiments of the invention provide the architecture for real-time distribution of data required to understand the hidden cost.

For the purpose of this application, a distribution index, also known as a “per-share distribution index” comprises one or more of an estimate of a security's undistributed income per share for a payment period of interest and an exact value of a security's undistributed income per share for the payment period of interest. According to embodiments of the invention, the systems divides the distribution index by the security price to calculate a per-share distribution percentage for the payment period of interest.

For the purpose of this application, a hidden cost comprises a per-share hidden cost to the user if the user purchases or sells shares. Multiplying the per-share hidden cost by the number of shares the user wishes to purchase or sell computes the estimated potential loss the user will suffer if they purchase or sell shares. In the case of a security with multiple distribution types, the system computes a per-share hidden cost for each type of distribution a security pays.

Embodiments of the invention compute the distribution index to account for a portion of a security's value that represents one or more of a dividend, a capital gain, and another distribution type.

Embodiments of the invention provide the distribution index that is configured to be communicated to one or more of a user, a financial services firm and another data-receiving entity. The system uses the distribution index to quantify the hidden cost inherent in income-producing securities.

An income-producing security will have at least one distribution index. In addition to a dividend, a security can have more than one distribution index to account for the various types of income being distributed. A security distributes one or more distribution types. For example, a security distributes two or more distribution types. The distribution type comprises one or more of income, cash, a short-term capital gain, a long-term capital gain, a special cash distribution, and another distribution type.

Additionally, if a distribution comprises multiple types of income that are taxed at different rates, separate indexes can be created to represent hidden cost associated with at least two different types of income. Preferably, but not necessarily, the server is further configured to compute a hidden cost for each distribution type from the security. Preferably, but not necessarily, the system creates separate indexes to represent a hidden cost associated with each type of income.

According to embodiments of the invention, the system aggregates financial data from several sources into a centralized database. The financial information comprises one or more of the security's price, an ex-dividend date of the security, an announcement dates on which information regarding the security is scheduled to be announced, a Committee on Uniform Security Identification Procedures (CUSIP) identifier, another unique security identifier, a ticker symbol, a distribution payment frequency, a custom security tag, payment period information for the security, an estimated periodic total distribution per share for each type of income distributed by the security, a type of distribution for the security, holding period requirements for the security, and information related to one or more of security earnings, security profits, security type, and tax information related to the distribution of the security. One or more of the capital gain data and the distribution data may be obtained from one or more of an investment fund manager and another financial data source.

The server analyzes financial data available in the database. Using the financial data, the server produces a computation, for at least one income-producing security, of a total upcoming financial distribution by the security. Preferably, but not necessarily, using the financial data, the server produces a computation, for each income-producing security, of the total upcoming financial distribution by the security. A distribution index will be produced for each type of income that will be distributed from each security.

The server then computes the portion of a security's price that represents the security's undistributed income using a distribution index.

FIG. 1 illustrates an exemplary system 100 for computing a hidden cost that the user assumes when they do one or more of purchase and sell an income-producing security. FIG. 1 illustrates a system 100 that can be constructed and operated using physical onsite components. Alternatively, or additionally, the system 100 illustrated in FIG. 1 could also be constructed and operated using a cloud-based system architecture. Preferably, but not necessarily, FIG. 1 depicts the system 100 suitable for use with physical onsite components. Alternatively, or additionally, in the case of a cloud-based system architecture, the cloud-based system comprises a system sold by Amazon Web Services (AWS), a subsidiary of Amazon.com of Seattle, Washington (www.amazon.com).

The system 100 comprises a server 110, the server 110 configured to do one or more of process data and control the system 100. The server 110 comprises computer code usable to process the data. The system 100 further comprises a user device 120 operated by a user (not shown), the user device 120 operably connected to the server 110. For example, the user device 120 comprises one or more of a desktop computer, a laptop computer, a notebook computer, a tablet, a mobile telephone, a smart watch, and another user device. The server 110 and the user device 120 are configured to communicate with each other. As depicted, the system further comprises a network 125.

For example, the server 110 communicates with the user device 120 via one or more of a network connection using the network 125, the cloud, a wired connection, and another connection. The network comprises a server-device network connection 125A operably connecting the server 110 and the user device 120. As depicted, the server 110 communicates with the user device 120 via the server-device network connection 125A. The network 125 comprises one or more of a wired network, a wireless network, and another network. Preferably, but not necessarily, the network 125 comprises a wired network.

The server 110 comprises a login module (not shown) suitable for use by the user device 120 to log into the server 110. The system 100 further comprises a user interface (not shown) suitable for use by the user device 120 to interface with the server 110 following a successful login to the server 110. Using the server-device network connection 125A, which connects the server 110 to the user device 120, the user (not shown) uses the user device 120 to access the login module provided by the server 110. Using the login module, the user device 120 accesses the server 110 via the user interface.

The system 100 further comprises a system database 130, the system database 130 operably connected to the server 110. The network 125 further comprises a server-database connection 125B operably connecting the server 110 and the system database 130. The system database 130 is configured to maintain on a regular basis an estimated financial distribution of a security of interest. Preferably, but not necessarily, the system database 130 maintains on a regular basis the estimated financial distributions of all income-producing securities of interest. Most preferably, but not necessarily, the system database 130 maintains on a regular basis the estimated financial distributions of all income-producing securities. For example, the system database 130 maintains on a daily basis the estimated financial distributions of the securities.

The system further comprises a securities data source 135, the securities data source operably connected to the system database 130. The system database 130 is further configured to receive the securities data from the securities data source 135. The network 125 further comprises a source-database connection 125C operably connecting the securities data source 135 and the system database 130. The securities data source 135 provides securities data to the system database 130. For example, the securities data source 135 provides on a regular basis to the system database 130 securities data comprising an estimated financial distribution of a security of interest. Preferably, but not necessarily, the securities data source 135 provides to the system database 130 on a regular basis securities data comprising the estimated financial distributions of all income-producing securities of interest. Most preferably, but not necessarily, the securities data source 135 provides on a regular basis to the system database 130 securities data comprising the estimated financial distributions of all income-producing securities. For example, the securities data source 135 provides on a daily basis to the system database 130 securities data comprising estimated financial distributions of the securities.

The system database 130 provides on a regular basis to the server 110 an estimated financial distribution of a security of interest. Alternatively, or additionally, the user device 120 sends to the server 110 a request for a hidden cost of a security of interest. The system database 130 then provides the hidden cost of the security of interest. Preferably, but not necessarily, the system database 130 provides to the server 110 on a regular basis the estimated financial distributions of all income-producing securities of interest. Most preferably, but not necessarily, the system database 130 provides to the server 110 on a regular basis the estimated financial distributions of all income-producing securities. For example, the system database 130 provides to the server 110 on a daily basis estimated financial distributions of the securities.

The server 110 then uses the estimated financial distribution to calculate a distribution index for a security of interest.

The system 100 further comprises storage 150 configured to store data, the storage 150 operably connected to the server 110. The network 125 further comprises a server-storage network connection 125D operably connecting the server 110 and the storage 150. The network 125 is configured to operably connect two or more of the server 110, the user device 120, the system database 130, the securities data source 135, and the storage 150.

Via the server-database network connection 125B, the server accesses the security database 135 to obtain security information needed to calculate hidden cost. Using the security information thereby obtained, and using the method for computing hidden cost, the server computes the hidden cost, thereby producing computed data 154. For example, the computed data 154 comprises one or more of the security's distribution index and the security's hidden cost. The server 110 transmits one or more of the computed data 154 to the storage 150 via the server-storage network connection 125D that connects the server 110 to the storage 150. The storage 150 stores the computed data 154.

One or more of a user using the user device 120 and an intermediary (not shown) authorized by the user can request to receive the computed data 154 comprising one or more of the distribution index and the hidden cost of a security of interest. For example, the user device 120 can request to receive the hidden cost of a security of interest. The server 110 retrieves from the user device 120 the request for the hidden cost of the security of interest. For example, the intermediary comprises one or more of an accountant, a tax advisor, a broker-dealer, a custodian, and a data provider. For example, the intermediary comprises Charles Schwab Corporation of Westlake, Texas (www.schwab.com). For example, the intermediary comprises Yahoo Finance of New York City (http:/finance.yahoo.com). The server then exports the computed data 154 comprising one or more of the computed distribution index and the computed hidden cost back to the one or more of the user device 120 and the intermediary authorized by the user.

Using the user device 120 over the server-device network connection 125A, the user can request the computed data 154. Using the server-storage network connection 125D, the server 110 retrieves the computed data 154 from the storage 150. The server 110 sends the requested computed data 154 to the user device 120 via the server-device network connection 125A. Instead of directly requesting computed data 154 via the server-device network connection 125A, the user can instead use the intermediary to receive the computed data 154. The network 125 further comprises a server-intermediary network connection 125E operably connecting the server 110 and the intermediary 165.

The server 110 then does one or more of sending the requested computed data 154 via the server-device network connection 125A via the user device 120 to the user (not shown) and sending the requested computer data 154 via the server-intermediary network connection 125E to the intermediary 165. For example, the server 110 sends the requested computed data 154 to the intermediary 165 using one or more of an output module (not shown), and an application programming interface (API) socket (not shown).

The server 110 communicates the distribution index computation to the user device 120 using the server-device connection 125A. For example, the server 110 comprises an output module (not shown). For example, the server 110 communicates the distribution index computation to the user device 120 through the output module (not shown). The output module can use various communication methods to send data to users. Data can be communicated via one or more of a data feed, an application programming interface (API), and another data communication method. Data can be communicated over a network, communicated onsite or communicated using another communication method. The network can be one or more of wireless and wired.

The output module communicates the hidden cost data to one or more of an intermediary and an end user.

Intermediaries can comprise one or more of a custodian, a broker-dealer, a financial services firm, a data distribution company and another intermediary. Intermediaries can then redistribute the data to the end users.

Alternatively, or additionally, the system communicates the hidden cost data from the output module directly to the end users.

To compute the distribution index, the server uses the following equation:

$$Distribution Index = \{ \begin{matrix}D for purchases of a stock ; \\ ( D * \frac{T}{L} ) for a purchase of an investment fund\end{matrix} , \qquad ( 1 )$$

where: D=the total distribution per share, T=the amount of elapsed time since the payment period began, and L=the total amount of time in the payment period. Where T is the total amount of time in the payment period, where D is the estimated distribution per share the server retrieves from the system database, and where E is the total amount of time that has elapsed since the beginning of the payment period and ending with the day and time for which a user wishes to generate a hidden cost assessment. For example, if the payment period began 7 days ago, then E=7, if the unit of time is equal to a day.

Estimated financial distributions can be retrieved from a data provider. Alternatively, or additionally, the estimated financial distribution can be produced by the server by analyzing historical distribution data. For example, the data provider comprises Bloomberg L.P. of New York, NY (www. Bloomberg.com).

The distribution index can be expressed in a currency, or it can be expressed as a percentage by dividing the distribution index by the current price of the security.

According to embodiments of the invention, the server is continuously processing the hidden cost for a security in the database. Preferably, but not necessarily, the server is continuously processing the hidden cost for each security in the database. Hidden cost can be expressed on one or more of a real-time basis, an end of day basis, and another processing schedule.

For each security in the centralized database, the system can communicate supplementary hidden cost. The supplementary hidden cost can help users do one or more of better understand their hidden costs, minimize losses, and make better trading decisions. The supplementary hidden cost comprises one or more of a number of days until a next ex-dividend day, an estimated loss associated with different tax rates, an indicator regarding a type of tax the user will pay, a degree to which hidden cost adversely impacts the user's purchasing power, the security's total cost of ownership, a security's hidden cost, tax information on how different types of income within a distribution are characterized from a tax perspective, and another data point usable to evaluate the user's hidden cost when purchasing income-producing securities. For example, the type of tax comprises one or more of a qualified income, ordinary income, a short term capital gain, a long term capital gain, and another type of tax.

The embodiments of the invention are configured to disseminate data to users for the purpose of informing the user of potential excess tax they may have to pay if they sell their securities prior to a distribution.

The system computes a user's hidden cost when purchasing an income-producing security using the following equation:

$$Purchaser ’ s Hidden Cost = S * R * ( Distribution Index ) = S * R * \{ \begin{matrix}D for purchases of a stock ; \\ ( D * \frac{T}{L} ) for a purchase of an investment fund\end{matrix} , \qquad ( 2 )$$

where: S=the number of shares the user wants to purchase, R=the user's tax rate on investment income, D=the total distribution per share, T=the amount of elapsed time since the payment period began, and L=the total amount of time in the payment period. For example, the tax rate comprises one or more of a federal tax rate, a state tax rate, a provincial tax rate, a municipal tax rate, a county tax rate, a European community tax rate, a tax rate of another community of nations, and another tax rate. When the user's specific tax rate is unknown, the system is configured to do one or more of compute a tax rate estimate and provide a range of tax rates.

This equation can be repeated for multiple types of distribution income that a security will distribute where D=a type of income. For example, this equation can be repeated for each type of distribution income that a security will distribute. For example, for a security that will pay both a short-term and a long-term gain, the system repeats the equation twice and the system creates two distributions indexes, one index for the short-term gain and one index for the long-term gain.

The system computes a purchaser's hidden cost per share for a purchase of an income-producing security using the following equation:

$$Purchaser ’ s Hidden Cost Per Share = R * ( Distribution Index ) = R * \{ \begin{matrix}D for purchases of a stock ; \\ ( D * \frac{T}{L} ) for a purchase of an investment fund\end{matrix} , \qquad ( 3 )$$

where: R=the user's tax rate on investment income, D=the total distribution per share, T=the amount of elapsed time since the payment period began, and L=the total amount of time in the payment period. The system is configured to compute a hidden cost per share for every type of distribution from a security. The hidden cost per share for each type of distribution can then be aggregated to compute a total hidden cost per share for a security. A user can then multiply the number of shares they wish to purchase by the total hidden cost per share to determine the total hidden cost of buying the security.

The system distributes the computed hidden cost per share to end users as part of the hidden cost data set.

According to further embodiments of the invention, the distribution index can be used to forecast an estimate of earned income for an income-producing security.

The system computes a purchasing user's earned income from each distribution type using the following equation:

$$Purchaser ’ s Earned Income = S * ( Distribution Index ) = S * \{ \begin{matrix}D for purchases of a stock ; \\ ( D * \frac{T}{L} ) for a purchase of an investment fund\end{matrix} , \qquad ( 5 )$$

where: S=a number of shares a user purchases, D=the total distribution per share, T=the amount of elapsed time since the payment period began, and L=the total amount of time in the payment period.

The system computes a user's hidden cost when selling an income-producing security using the following equation:

$$Seller ’ s Hidden Cost = S * ( C - Q ) * ( Distribution Index ) = S * ( C - Q ) * \{ \begin{matrix}D for sales of a stock ; \\ ( D * \frac{T}{L} ) for a sale of an investment fund\end{matrix} , \qquad ( 6 )$$

where: S=a number of shares a user wishes to sell, C=the tax rate on capital gains, Q=the tax rate on qualified income, D=the total distribution per share, T=the amount of elapsed time since the payment period began, and L=the total amount of time in the payment period. For example, capital gains are taxed at a higher rate than qualified income.

Embodiments of the invention are configured to compute earned income on a real-time basis, periodic basis or on-demand.

Earned income from each distribution type can be calculated and transmitted separately, can be grouped or can be totaled. The system is also configured to compute periodic earned income for varying numbers of shares owned during a payment period. For example, the system can compute daily earned income by subtracting the value of the distribution index today, minus the value of the distribution index of the previous day and then multiplying that mathematical outcome by the number of shares owned during that period. The system performs this calculation regularly. For example, the system performs this calculation daily. Preferably, but not necessarily, the system performs this calculation every day. The system creates a cumulative total representing the income earned for a payment period.

Hidden cost can be disseminated to end users in various formats. For example, hidden cost can be incorporated into a trade confirmation dialog box. For example, the hidden cost can be incorporated into the trade confirmation dialog box provided by one or more of a broker and a custodian. Preferably, but not necessarily, when a user wishes to purchase a security, they will agree to terms of the trade in one or more of a trade confirmation screen and a trade dialog box. The trade confirmation screen shows the user one or more of a number of shares they will purchase, an estimated commission amount, a security they are purchasing, an order type, and other trade confirmation information regarding the trade that is about to be executed. Hidden cost can be incorporated into the trade confirmation screen so as to inform the user regarding an estimated hidden cost. For example, the system provides the estimated hidden cost in one or more of United States dollars, British pounds, Canadian dollars, Australian dollars, New Zealand dollars, euros, and another currency. By clicking a “confirm or send” button, the user acknowledges one or more of that they understand the hidden cost they are assuming and their agreement to assume the hidden cost they are assuming.

Hidden cost can also be incorporated into security issuers′, custodians′, brokers′, data providers' and other intermediaries' online websites. When a user is researching a security for purchase, they will be able to see the hidden cost they will be assuming in advance of the trade. Armed with the hidden cost, a user can do one or more of search for alternatives and adjust timing of their trade to better manage their portfolio. The hidden cost can be used in numerous ways that allow fiduciaries the ability to meet their legal disclosure obligations.

The system is configured to use one or more of hidden cost and predictive analytics to make a customized recommendation to a user. For example, the system creates the customized recommendation for the purpose of improving hidden cost management. Alternatively, or additionally, the system creates the customized recommendation for the purpose of protecting the user from potential harm. Alternatively, or additionally, the system creates the customized recommendation for purposes of both improving hidden cost management and protecting the user from potential harm. For example, the system can recommend alternative securities that have an improved hidden cost profile. For example, the system can recommend delaying a purchase or sale for a number of days. For example, the system is configured to provide strategies for increasing after-tax returns and maximizing user purchasing power.

The system includes a plurality of components such as one or more of electronic components, hardware components, and computer software components. A number of such components can be combined or divided in the system. An example component of the system includes a set and/or series of computer instructions written in or implemented with any of a number of programming languages, as will be appreciated by those skilled in the art.

The system in one example employs one or more computer-readable signal-bearing media. The computer-readable signal bearing media store software, firmware and/or assembly language for performing one or more portions of one or more implementations of the invention. The computer-readable signal-bearing medium for the system in one example comprises one or more of a magnetic, electrical, optical, biological, and atomic data storage medium. For example, the computer-readable signal-bearing medium comprises one or more of floppy disks, magnetic tapes, CD-ROMs, DVD-ROMs, hard disk drives, downloadable files, files executable “in the cloud,” electronic memory, and another computer-readable signal-bearing medium.

Any logic or application described herein that comprises software or code can be embodied in any non-transitory computer-readable medium for use by or in connection with an instruction execution system in a computer system or other system. In this sense, the logic may comprise, for example, statements including instructions and declarations that can be fetched from the computer-readable medium and can be executed by the instruction execution system. In the context of the present disclosure, a computer-readable medium can be any medium that can contain, store, or maintain the logic or application described herein for use by or in connection with the instruction execution system. For example, the computer-readable medium may comprise one or more of random access memory (RAM), read-only memory (ROM), hard disk drive, solid-state drive, USB flash drive, memory card, floppy disk, optical disc such as compact disc (CD) or digital versatile disc (DVD), magnetic tape, and other memory components. For example, the RAM may comprise one or more of static random access memory (SRAM), dynamic random access memory (DRAM), magnetic random access memory (MRAM), and other forms of RAM. For example, the ROM may comprise one or more of programmable read-only memory (PROM), erasable programmable read-only memory (EPROM), electrically erasable programmable read-only memory (EEPROM), and other forms of ROM.

The below tables show an example of the system computing the hidden costs from multiple distribution types:

| | |
|---|---|
| 1,000 | <Number of Shares to Purchase |
| 20% | <Tax Rate for Dividends and Long-Term Capital Gains |
| 40% | <Tax Rate on Short-Term Capital Gains |

| | Estimated | Distribution | Hidden |
|---|---|---|---|
| | Distribution | Index | Cost |
| Dividend | $1.00 | $0.50 | $ 100.00 |
| Long-Term Capital Gain | $4.00 | $2.00 | $400.00 |
| Short-Term Capital Gain | $2.00 | $1.00 | $400.00 |
| | | Total Hidden Cost | $900.00 |

The tables show the purchase of 1,000 shares of a security of interest and assumes a 20% tax rate for dividends and long-term capital gains and a 40% tax rate for short-term capital gains. For each distribution type an estimated distribution is provided. Additionally, for each distribution type, the system computes a distribution index. The system computes a hidden cost for the purchase of 1,000 shares for each distribution type. Additionally, the system adds the hidden cost for each distribution type, computing a total hidden cost for this purchase of 1,000 shares of $900.00.

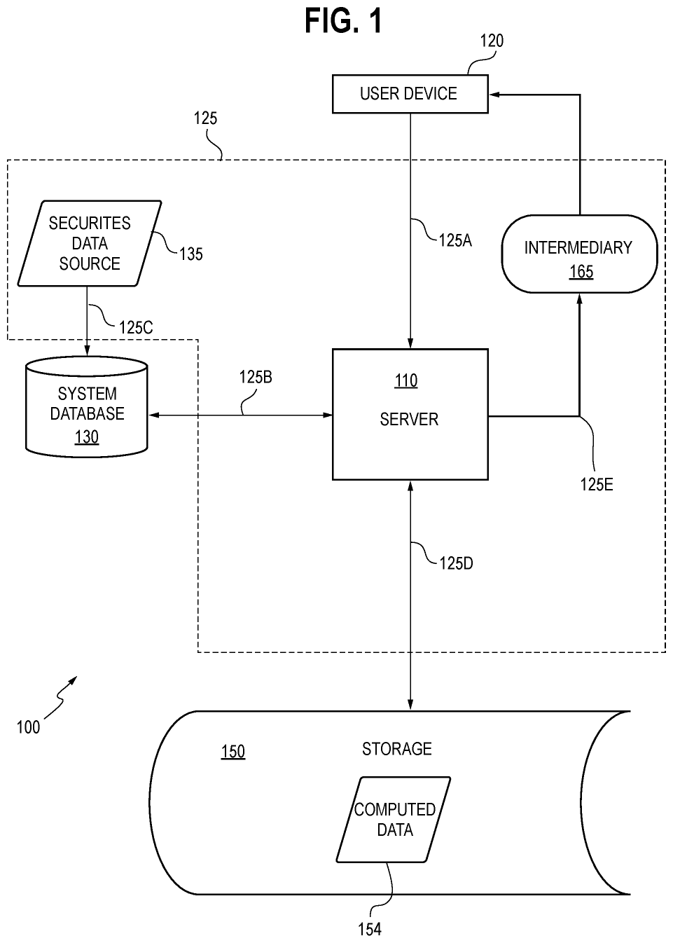

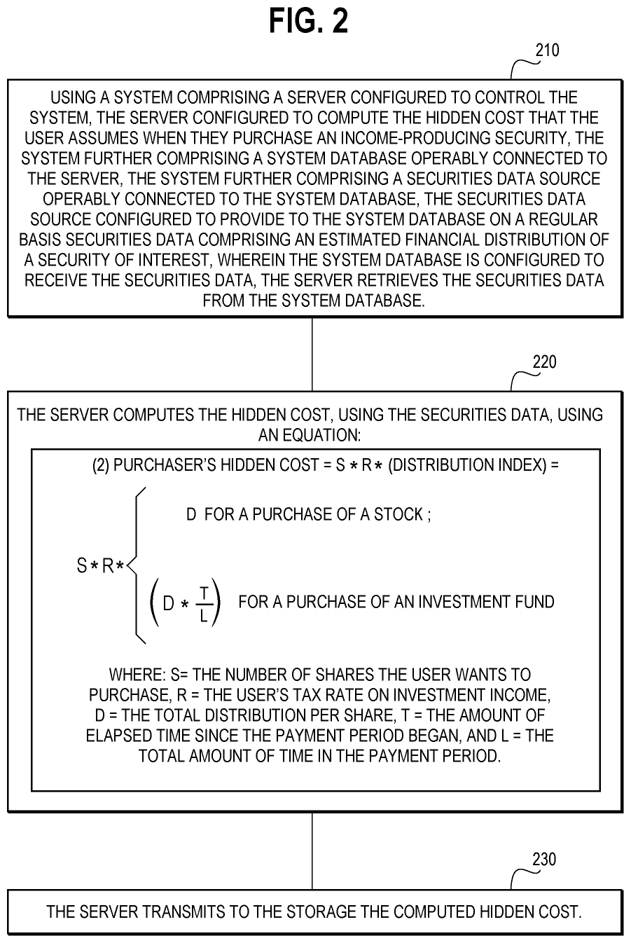

FIG. 2 is a flow chart of a method 200 for computing a hidden cost of an income-producing security that a user assumes when they purchase the security.

The order of the steps in the method 200 is not constrained to that shown in FIG. 2 or described in the following discussion. Several of the steps could occur in a different order without affecting the final result.

In step 210, using a system comprising a server configured to control the system, the server configured to compute the hidden cost that the user assumes when they purchase an income-producing security, the system further comprising a system database operably connected to the server, the system further comprising a securities data source operably connected to the system database, the securities data source configured to provide to the system database on a regular basis securities data comprising an estimated financial distribution of a security of interest, wherein the system database is configured to receive the securities data, the server retrieves the securities data from the system database. For example, the retrieving step further comprises retrieving the securities data on a daily basis. For example, the retrieving step further comprises retrieving from a user device a request for the hidden cost of a security of interest. Block 210 then transfers control to block 220.

In step 220, the server computes the hidden cost, using the securities data, using an equation:

$$Purchaser ’ s Hidden Cost = S * R * ( Distribution Index ) = S * R * \{ \begin{matrix}D for purchases of a stock ; \\ ( D * \frac{T}{L} ) for a purchase of an investment fund\end{matrix} , \qquad ( 2 )$$

where: S=the number of shares the user wants to purchase, R=the user's tax rate on investment income, D=the total distribution per share, T=the amount of elapsed time since the payment period began, and L=the total amount of time in the payment period. For example, the computing step comprises a sub-step of computing, by the server, the hidden cost for each distribution type from the security. For example, the computing step comprises a sub-step, performed after the sub-step of computing the hidden cost for each distribution type from the security, of storing in the storage the hidden costs computed for each distribution type. Block 220 then transfers control to block 230.

In step 230, the server transmits to the storage the computed hidden cost. Block 230 then terminates the process.

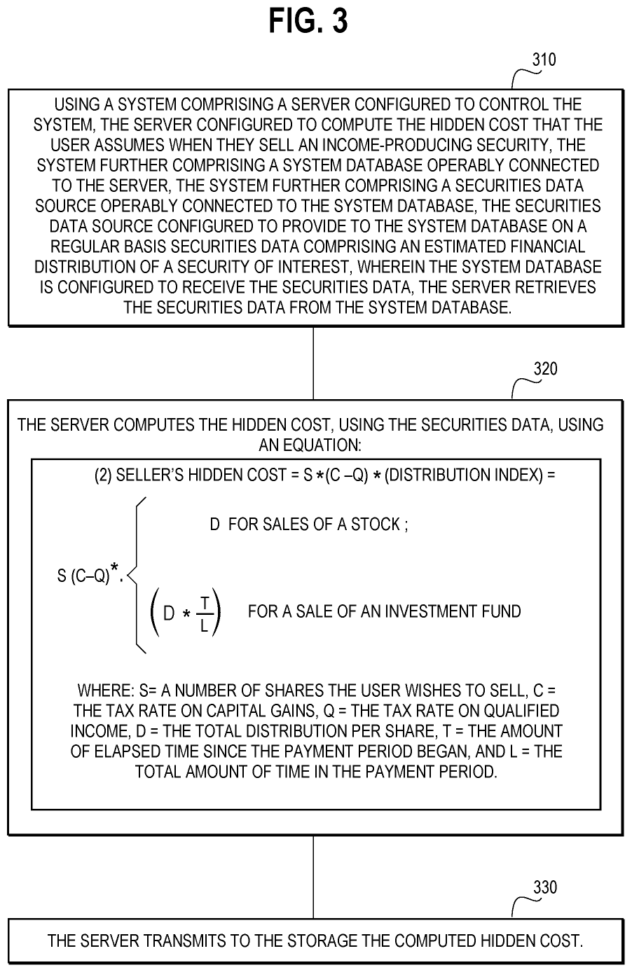

FIG. 3 is a flow chart of a method 300 for computing a hidden cost of an income-producing security that a user assumes when they sell the security.

The order of the steps in the method 300 is not constrained to that shown in FIG. 3 or described in the following discussion. Several of the steps could occur in a different order without affecting the final result.

In step 310, using a system comprising a server configured to control the system, the server configured to compute the hidden cost that the user assumes when they purchase an income-producing security, the system further comprising a system database operably connected to the server, the system further comprising a securities data source operably connected to the system database, the securities data source configured to provide to the system database on a regular basis securities data comprising an estimated financial distribution of a security of interest, wherein the system database is configured to receive the securities data, the server retrieves the securities data from the system database. For example, the retrieving step further comprises retrieving the securities data on a daily basis. For example, the retrieving step further comprises retrieving from a user device a request for the hidden cost of a security of interest. Block 310 then transfers control to block 320.

In step 320, the server computes the hidden cost, using the securities data, using an equation:

$$Seller ’ s Hidden Cost = S * ( C - Q ) * ( Distribution Index ) = S ( C - Q ) * \{ \begin{matrix}D for sales of a stock ; \\ ( D * \frac{T}{L} ) for a sale of an investment fund\end{matrix} , \qquad ( 6 )$$

where: S=a number of shares the user wishes to sell, C=the tax rate on capital gains, Q=the tax rate on qualified income, D=the total distribution per share, T=the amount of elapsed time since the payment period began, and L=the total amount of time in the payment period. For example, the computing step comprises a sub-step of computing, by the server, the hidden cost for each distribution type from the security. For example, the computing step comprises a sub-step, performed after the sub-step of computing the hidden cost for each distribution type from the security, of storing in the storage the hidden costs computed for each distribution type. Block 320 then transfers control to block 330.

In step 330, the server transmits to the storage the computed hidden cost. Block 330 then terminates the process.

An advantage of embodiments of the invention includes one or more of helping and allowing financial services firms to meet one or more of their regulatory disclosure requirements to users and their legal disclosure requirements to users.

A further advantage of embodiments of the invention is allowing a purchaser of an income-producing security to understand their potential hidden cost before committing capital.

A still other advantage of embodiments of the invention is allowing a seller of an income-producing security to understand a potential increase in taxes paid as a result of selling their security.

A yet other advantage of embodiments of the invention is that the ability provided by embodiments of the invention to forecast earned income of an income-producing security is advantageous for reporting security investment returns and performance. A still further advantage of embodiments of the invention is that the ability provided by embodiments of the invention to forecast earned income of an income-producing security is advantageous to understand a user's potential tax liability and income potential.

Another advantage of embodiments of the invention is allowing users to understand hidden costs on a real-time basis.

A still other advantage of embodiments of the invention is allowing a user to understand hidden costs associated with a security. A further advantage of embodiments of the invention is allowing a user to understand hidden costs associated with a security at any time. A yet other advantage of embodiments of the invention is allowing a user to do one or more of compare and consider alternative securities based upon their respective distribution hidden cost profiles.

A yet additional advantage of embodiments of the invention is allowing a user to determine by how much their purchasing power could be impacted by purchasing a security with undistributed income being included in a price of the security. Another advantage of embodiments of the invention is thereby reducing disadvantages of reduced purchasing power, including one or more of fewer shares being purchased and lower security yields.

A still other advantage of embodiments of the invention is allowing the user to better understand the hidden cost of purchasing income-producing securities. A further advantage of embodiments of the invention is facilitating user purchase of income-producing securities, which, if managed well, result in one or more of a higher after-tax investment return and an accumulation of more shares.

A yet further advantage of embodiments of the invention is allowing the user to better time their investment decisions. A still other advantage of embodiments of the invention is allowing the user to better time their investment decisions so as to avoid unnecessary tax. Another advantage of embodiments of the invention is that a user armed with hidden cost provided by embodiments of the invention may wait until a security pays its distributions before purchasing it.

A still further advantage of embodiments of the invention is it allows the user to understand hidden cost associated with purchasing securities that pay capital gain distributions.

A yet other advantage of embodiments of the invention is that pre-trade confirmation of hidden cost allows financial service firms to meet their disclosure obligations as they have the user's confirmation that they agree to hidden cost associated with a trade.

A still further advantage of the embodiments of the invention is providing the ability to estimate a user's earned income for one or more of a security and a portfolio of securities.

While the above representative embodiments have been described with certain components in exemplary configurations, it will be understood by one of ordinary skill in the art that other representative embodiments can be implemented using different configurations and/or different components. For example, it will be understood by one of ordinary skill in the art that the order of certain steps and certain components can be altered without substantially impairing the functioning of the invention.

The representative embodiments and disclosed subject matter, which have been described in detail herein, have been presented by way of example and illustration and not by way of limitation. It will be understood by those skilled in the art that various changes may be made in the form and details of the described embodiments resulting in equivalent embodiments that remain within the scope of the invention. It is intended, therefore, that the subject matter in the above description shall be interpreted as illustrative and shall not be interpreted in a limiting sense.

What is claimed is:

1. A system for computing a hidden cost that a user assumes when they purchase an income-producing security, comprising:
a server configured to control the system, the server further configured to compute the hidden cost that the user assumes when they purchase the income-producing security;
a system database operably connected to the server;
a securities data source operably connected to the system database, the securities data source configured to provide to the system database on a regular basis securities data comprising an estimated financial distribution of a security of interest, wherein the system database is configured to receive the securities data, wherein the server is further configured to compute the hidden cost, using the securities data, using an equation:
$$Purchaser ’ s Hidden Cost = S * R * ( Distribution Index ) = S * R * \{ \begin{matrix}D for purchases of a stock ; \\ ( D * \frac{T}{L} ) for a purchase of an investment fund\end{matrix} , \qquad ( 2 )$$
where: S=the number of shares the user wants to purchase, R=the user's tax rate on investment income, D=the total distribution per share, T=the amount of elapsed time since the payment period began, and L=the total amount of time in the payment period; and
storage operably connected to the server, the storage configured to store the computed hidden cost.

2. The system of claim 1, further comprising a user device operated by a user, the user device operably connected to the server.

3. The system of claim 2, wherein the user device is configured to send to the server a request for the hidden cost of a security of interest.

4. The system of claim 2, wherein the user device comprises one or more of a desktop computer, a laptop computer, a notebook computer, a tablet, a mobile telephone, and a smart watch.

5. The system of claim 2, further comprising a network.

6. The system of claim 5, wherein the network is configured to operably connect two or more of the server, the user device, the system database, the securities data source, and the storage.

7. The system of claim 5, wherein the network comprises one or more of a server-device network connection operably connecting the server and the user device, a server-database network connection operably connecting the server and the system database, a source-database connection connecting the data source and the system database, and a server-storage network connection operably connecting the server and the storage.

8. The system of claim 3, wherein the server communicates with the user device via one or more of a network connection, the cloud, and a wired connection.

9. The system of claim 2, wherein the server comprises a login module suitable for use by the user device to log into the server.

10. The system of claim 9, wherein the server further comprises a user interface suitable for use by the user device to interface with the server following a successful login to the server.

11. The system of claim 1, wherein the securities data source provides the securities data to the system database on a daily basis.

12. The system of claim 7, wherein the server is further configured to export the computed hidden cost to one or more of the user device and an intermediary authorized by the user.

13. The system of claim 12, wherein the intermediary comprises one or more of an accountant, a tax advisor, a broker-dealer, a custodian, and a data provider.

14. The system of claim 1, wherein the security distributes one or more distribution types.

15. The system of claim 14, wherein the distribution types are selected from a list comprising: income, cash, a short-term capital gain, a long-term capital gain, and a special cash distribution.

16. The system of claim 15, wherein the server is further configured to compute a hidden cost for each distribution type from the security.

17. The system of claim 16, wherein the server transmits to the storage the hidden cost computed for each distribution type.

18. The system of claim 13, the network further comprising a server-intermediary network connection operably connecting the server and the intermediary.

19. The system of claim 1, wherein the tax rate comprises one or more of a federal tax rate, a state tax rate, a provincial tax rate, a municipal tax rate, a county tax rate, a European community tax rate, and a tax rate of another community of nations.

20. A system for computing a hidden cost that a user assumes when they sell an income-producing security, comprising:
a server configured to control the system, the server further configured to compute the hidden cost that the user assumes when they sell the income-producing security;
a system database operably connected to the server;
a securities data source operably connected to the system database, the securities data source configured to provide to the system database on a regular basis securities data comprising an estimated financial distribution of a security of interest, wherein the system database is configured to receive the securities data, wherein the server is further configured to retrieve the securities data from the system database, wherein the server is further configured to compute the hidden cost, using the securities data, using an equation:
$$Seller ’ s Hidden Cost = S * ( C - Q ) * ( Distribution Index ) = S * ( C - Q ) * \{ \begin{matrix}D for sales of a stock ; \\ ( D * \frac{T}{L} ) for a sale of an investment fund\end{matrix} , \qquad ( 6 )$$
where: S=a number of shares the user wishes to sell, C=the tax rate on capital gains, Q=the tax rate on qualified income, D=the total distribution per share, T=the amount of elapsed time since the payment period began, and L=the total amount of time in the payment period; and
storage operably connected to the server, the storage configured to store the computed hidden cost.

21. The system of claim 20, further comprising a user device operated by a user, the user device operably connected to the server.

22. The system of claim 21, wherein the user device is configured to send to the server a request for the hidden cost of a security of interest.

23. The system of claim 21, wherein the user device comprises one or more of a desktop computer, a laptop computer, a notebook computer, a tablet, a mobile telephone, and a smart watch.

24. The system of claim 21, further comprising a network.

25. The system of claim 24, wherein the network is configured to operably connect two or more of the server, the user device, the system database, the securities data source, and the storage.

26. The system of claim 24, wherein the network comprises one or more of a server-device network connection operably connecting the server and the user device, a server-database network connection operably connecting the server and the system database, a source-database connection connecting the data source and the system database, and a server-storage network connection operably connecting the server and the storage.

27. The system of claim 22, wherein the server communicates with the user device via one or more of a network connection, the cloud, and a wired connection.

28. The system of claim 21, wherein the server comprises a login module suitable for use by the user device to log into the server.

29. The system of claim 28, wherein the server further comprises a user interface suitable for use by the user device to interface with the server following a successful login to the server.

30. The system of claim 20, wherein the securities data source provides the securities data to the system database on a daily basis.

31. The system of claim 26, wherein the server is further configured to export the computed hidden cost to one or more of the user device and an intermediary authorized by the user.

32. The system of claim 31, wherein the intermediary comprises one or more of an accountant, a tax advisor, a broker-dealer, a custodian and a data provider.

33. The system of claim 20, wherein the security distributes one or more distribution types.

34. The system of claim 33, wherein the distribution types are selected from a list comprising: income, cash, a short-term capital gain, a long-term capital gain, and a special cash distribution.

35. The system of claim 34, wherein the server is further configured to compute a hidden cost for each distribution type from the security.

36. The system of claim 35, wherein the server transmits to the storage the hidden cost computed for each distribution type.

37. The system of claim 32, the network further comprising a server-intermediary network connection operably connecting the server and the intermediary.

38. The system of claim 20, wherein the tax rate comprises one or more of a federal tax rate, a state tax rate, a provincial tax rate, a municipal tax rate, a county tax rate, a European community tax rate, and a tax rate of another community of nations.

39. A method for computing the hidden cost that a user assumes when they purchase an income-producing security, comprising:
using a system comprising a server configured to control the system, the server configured to compute the hidden cost that the user assumes when they purchase an income-producing security, the system further comprising a system database operably connected to the server, the system further comprising a securities data source operably connected to the system database, the securities data source configured to provide to the system database on a regular basis securities data comprising an estimated financial distribution of a security of interest, wherein the system database is configured to receive the securities data, retrieving, by the server, the securities data from the system database;
computing the hidden cost, by the server, using the securities data, using an equation:
$$Purchaser ’ s Hidden Cost = S * R * ( Distribution Index ) = S * R * \{ \begin{matrix}D for purchases of a stock ; \\ ( D * \frac{T}{L} ) for a purchase of an investment fund\end{matrix} , \qquad ( 2 )$$
where: S=the number of shares the user wants to purchase, R=the user's tax rate on investment income, D=the total distribution per share, T=the amount of elapsed time since the payment period began, and L=the total amount of time in the payment period; and
transmitting, by the server, to the storage, the computed hidden cost, the system further comprising storage operably connected to the server, the storage configured to store the computed hidden cost.

40. The method of claim 39, wherein the storage stores the computed hidden cost.

41. The method of claim 40, wherein the security distributes one or more distribution types.

42. The method of claim 41, wherein the distribution types are selected from a list comprising: income, cash, a short-term capital gain, a long-term capital gain, and a special cash distribution.

43. The method of claim 39, wherein the retrieving step further comprises retrieving, by the server, from the user device, a request for the hidden cost of a security of interest.

44. The method of claim 41, wherein the computing step comprises a sub-step of computing, by the server, a hidden cost for each distribution type from the security.

45. The method of claim 39, wherein the retrieving step comprises retrieving, by the server, the securities data on a daily basis.

46. The system of claim 44, wherein the computing step comprises a sub-step, performed after the sub-step of computing the hidden cost for each distribution type from the security, by the server, of storing in the storage the hidden costs computed for each distribution type.

47. A method for computing the hidden cost that a user assumes when they sell an income-producing security, comprising:
using a system comprising a server configured to control the system, the server configured to compute the hidden cost that the user assumes when they sell an income-producing security, the system further comprising a system database operably connected to the server, the system further comprising a securities data source operably connected to the system database, the securities data source configured to provide to the system database on a regular basis securities data comprising an estimated financial distribution of a security of interest, wherein the system database is configured to receive the securities data, retrieving, by the server, the securities data from the system database;
computing the hidden cost, by the server, using the securities data, using an equation:
$$Seller ’ s Hidden Cost = S * ( C - Q ) * ( Distribution Index ) = S ( C - Q ) * \{ \begin{matrix}D for sale of a stock ; \\ ( D * \frac{T}{L} ) for a sale of an investment fund\end{matrix} , \qquad ( 6 )$$
where: S=a number of shares the user wishes to sell, C=the tax rate on capital gains, Q=the tax rate on qualified income, D=the total distribution per share, T=the amount of elapsed time since the payment period began, and L=the total amount of time in the payment period; and
transmitting, by the server, to the storage, the computed hidden cost, the system further comprising storage operably connected to the server, the storage configured to store the computed hidden cost.

48. The method of claim 47, wherein the storage stores the computed hidden cost.

49. The method of claim 47, wherein the security distributes one or more distribution types.

50. The method of claim 49, wherein the distribution types are selected from a list comprising: income, cash, a short-term capital gain, a long-term capital gain, and a special cash distribution.

51. The method of claim 47, wherein the retrieving step further comprises retrieving, by the server, from the user device, a request for the hidden cost of a security of interest.

52. The method of claim 49, wherein the computing step comprises a sub-step of computing, by the server, a hidden cost for each distribution type from the security.

53. The method of claim 47, wherein the retrieving step comprises retrieving, by the server, the securities data on a daily basis.

54. The method of claim 52, wherein the computing step comprises a sub-step, performed after the sub-step of computing the hidden cost for each distribution type from the security, by the server, of storing in the storage the hidden costs computed for each distribution type.

55. A system for computing a hidden cost that a user assumes when they purchase an income-producing security, comprising:
a server configured to control the system, the server further configured to compute the hidden cost that the user assumes when they purchase the income-producing security;
a user device operated by a user, the user device configured to send to the server a request for the hidden cost of a security of interest, the user device operably connected to the server, wherein the server communicates with the user device via one or more of a network connection, the cloud, and a wired connection, wherein the server comprises a login module suitable for use by the user device to log into the server, wherein the server further comprises a user interface suitable for use by the user device to interface with the server following a successful login to the server;
a system database operably connected to the server;
a securities data source operably connected to the system database, the securities data source configured to provide to the system database on a daily basis securities data comprising an estimated financial distribution of a security of interest, wherein the system database is configured to receive the securities data, wherein the server is further configured to compute the hidden cost, using the securities data, using an equation:
$$Purchaser ’ s Hidden Cost = S * R * ( Distribution Index ) = S * R * \{ \begin{matrix}D for purchases of a stock ; \\ ( D * \frac{T}{L} ) for a purchase of an investment fund\end{matrix} , \qquad ( 2 )$$
where: S=the number of shares the user wants to purchase, R=the user's tax rate on investment income, D=the total distribution per share, T=the amount of elapsed time since the payment period began, and L=the total amount of time in the payment period;
storage operably connected to the server, the storage configured to store the computed hidden cost, wherein the server is further configured to export the computed hidden cost to one or more of the user device and an intermediary authorized by the user, wherein the intermediary comprises one or more of an accountant, a tax advisor, a broker-dealer, and a custodian; and
a network configured to operably connect two or more of the server, the user device, the system database, the securities data source, the storage, and the intermediary, wherein the security distributes one or more distribution types, wherein the distribution types are selected from a list comprising: income, cash, a short-term capital gain, a long-term capital gain, and a special cash distribution, wherein the server is further configured to compute a hidden cost for each distribution type from the security, wherein the server transmits to the storage the hidden costs computed for each distribution type.

56. A system for computing a hidden cost that a user assumes when they sell an income-producing security, comprising:
a server configured to control the system, the server further configured to compute the hidden cost that the user assumes when they sell the income-producing security;
a user device operated by a user, the user device configured to send to the server a request for the hidden cost of a security of interest, the user device operably connected to the server, wherein the server communicates with the user device via one or more of a network connection, the cloud, and a wired connection, wherein the server comprises a login module suitable for use by the user device to log into the server, wherein the server further comprises a user interface suitable for use by the user device to interface with the server following a successful login to the server;
a system database operably connected to the server;
a securities data source operably connected to the system database, the securities data source configured to provide to the system database on a daily basis securities data comprising an estimated financial distribution of a security of interest, wherein the system database is configured to receive the securities data, wherein the server is further configured to retrieve the securities data from the system database, wherein the server is further configured to compute the hidden cost, using the securities data, using an equation:
$$Seller ’ s Hidden Cost = S * ( C - Q ) * ( Distribution index ) = S * ( C - Q ) * \{ \begin{matrix}D for sales of a stock ; \\ ( D * \frac{T}{L} ) for a sale of an investment fund\end{matrix} , \qquad ( 6 )$$
where: S=a number of shares the user wishes to sell, C=the tax rate on capital gains, Q=the tax rate on qualified income, D=the total distribution per share, T=the amount of elapsed time since the payment period began, and L=the total amount of time in the payment period;
storage operably connected to the server, the storage configured to store the computed hidden cost, wherein the server is further configured to export the computed hidden cost to one or more of the user device and an intermediary authorized by the user, wherein the intermediary comprises one or more of an accountant, a tax advisor, a broker-dealer, and a custodian; and
a network configured to operably connect two or more of the server, the user device, the system database, the securities data source, the storage, and the intermediary, wherein the security distributes one or more distribution types, wherein the distribution types are selected from a list comprising: income, cash, a short-term capital gain, a long-term capital gain, and a special cash distribution, wherein the server is further configured to compute a hidden cost for each distribution type from the security, wherein the server transmits to the storage the hidden costs computed for each distribution type.
